(19) United States
(12) Patent Application Publication
(10) Pub. No.: US 2012/0104007 A1
(43) Pub. Date: May 3, 2012

(54) ASSEMBLY FOR SEALING A ROUND TUBULAR OPENING THROUGH WHICH A TUBE DUCT OR CABLE EXTENDS

(75) Inventor: Johannes Alfred Beele, Aalten (NL)

(73) Assignee: Beele Engineering B.V., Aalten (NL)

(21) Appl. No.: 13/132,666

(22) PCT Filed: Jan. 28, 2010
(86) PCT No.: PCT/EP2010/050986

§ 371 Date: Aug. 8, 2011

(30) Foreign Application Priority Data
Feb. 2, 2009 (GB) 09016783

(51) Int. Cl. B65D 8/04; F16L 5/10; H02G 3/22

(52) U.S. Cl. 220/676; 277/606; 277/314

(57) ABSTRACT

An assembly of at least one pair of longitudinal plug segments for forming in an assembled condition at least a part of a rubber sealing plug for a round tubular opening such that each of the at least one pair of plug segments encloses at least one cylindrical recess for sealing occupation of at least one tube, duct or cable which extends through the opening in a longitudinal direction thereof.

The invention is related to an assembly for sealing a round tubular opening through which in a longitudinal direction thereof at least one tube, duct or cable extends. The invention further relates to use of such an assembly for providing a gas-tight compartment in which an end or an open part of a tube, duct or cable is positioned by extending into that compartment through a round tubular opening. The invention further relates to a gas-tight compartment provided with at least one round tubular opening through which in a longitudinal direction thereof at least one tube, duct or cable extends.

### BACKGROUND OF THE INVENTION

Systems for sealing openings through which pipes or cables extend have been known for a long time.

GB 2186442 describes a transit system for cables and pipes. The system comprises a metal frame having an opening filled with lead-through blocks and blanking blocks. The lead-through blocks comprise two half-blocks which can together form a block having an opening through which a pipe, cable or duct can be fed. In other words, two halves of the lead-through blocks can surround a pipe, cable or duct. Each pipe, cable or duct is thus surrounded by at least two blocks. The system allows for leading through a plurality of cables which have different diameters. This requires differently sized lead-through blocks. The remaining space in the opening is filled up with blank blocks. In this way, the space between the inner wall of the conduit sleeve, in case a metal frame, and the pipes, ducts or cables extending through the conduit sleeve or metal frame, is filled up with blocks. Usually, a stay plate is positioned between each layer of blocks. Pressure is then applied to the assembled blocks via the stay plate to compress the blocks around the cable, pipe or duct to seal the lead-through blocks around the cable, pipe or duct and to clamp them together and against the side walls of the frame or the conduit sleeve and to the stay plate. For this purpose, the system comprises a compression and packer system. Pressure can be applied by a system that requires tightening of nuts or compression bolts. The forces needed for compression are very high and partly passed on to the ducted pipe or cable, clearly often non-hydrostatically.

This system cannot distribute the load evenly throughout the stacking of blocks. In fact, the ducted pipe or cable will carry a part of the load and prevent an even distribution. The blocks which are much less subjected to compression “in the shade of the ducted pipe or duct” can easily be forced out. Another problem is the irreversible deformation of the rubber, which reduces the flexibility of the transit system which can be detrimental when a part of the system is suddenly exposed to a much higher pressure.

Apart from the fact that the system is difficult to install, time-consuming, costly, requiring a large inventory control, and much attention, the system further works unsatisfactorily in the long-run. Rubber, even well vulcanised rubber, has a natural relaxation occurring over time. When the rubber has not properly been saturated or vulcanised, also chemical relaxation can occur. This enhances the overall relaxation of the rubber. As a consequence of this, compression bolts or nuts of the compression and packer system of the system described in GB 2186442, needs to be retightened frequently. A further problem is that a change in temperature will due to thermal expansion or shrinkage result in loosening or over-tightening of the compression bolts, resulting in respectively weakening the sealing and irreversible deformation of the rubber.

In particular when plastic pipes or cables with plastic sheathing extend through the metal frame or conduit sleeve, the outer surface of these tubes or cables is subjected to radial inward pressure and the outer diameter of these plastic pipes may decrease due to a phenomenon known as “creep”. If this occurs, compression bolts and nuts of the compression and packer system should be retightened even more frequently as the integrity of the sealing provided by the compressed rubber blocks and the radially compressed plastic pipes, diminishes by both physical phenomena, creep and relaxation. However, no matter how frequently the compression bolts and/or nuts are retightened, immediately after retightening, the phenomena of relaxation of the rubber and creep of a plastic pipe will continue to occur so that the integrity of the sealing immediately further deteriorates.

If the core of the cable and the braiding of a cable are strong, the sheathing will have to cope with the stresses, possibly leading to irreversible deformations of the sheathing. If the braiding and/or the core of the cable is soft, these may irreversibly deform. Add to this that cables are never perfectly round, it is clear that the system in the long run introduces more and more irreversible deformation which locally varies. After replacement of a cable and/or blocks, it is difficult to re-establish good sealing.

GB 2140114 A describes a feed-through ducting arrangement for feeding cables, pipes or the like through an opening in a wall. The arrangement comprises partially or entirely elastic fitting members which fill the empty space of the opening in the wall and which seal on the one hand against the cables, pipes or the like, and on the other hand against the inner wall of the opening to be filled. A pressing device is provided for elastically pressing the fitting members into the wall opening.

In contrast to the system discussed above, the pressing device is arranged outside the empty space of the opening of the wall, and therefore the wall opening is available in its entirety for passing cables, pipes or the like therethrough.

The internal cross section of the opening diminishes from one side of the wall to the other and the pressing device having a clamping flange extending along the periphery of the opening on the side of the wall embracing the wider end of the opening partially engages over the fitting members at the front end thereof, from the edge of the wall opening, to press the fitting members axially into the wall opening. The packing which is formed from the assembly of all fitting members is pressed axially more deeper into the wall opening which reduces in width, whereby the fitting members are pressed against each other, against the cable, pipes or the like and against the inner wall of the opening, thereby giving a sealing action and a fireproofing action, without also requiring a frame assembly for enclosing the fitting members. The use of the pressing device having the clamping flange is cumbersome, but required to press the fitting members against each other to the extent that the resulting friction of the fitting members against each other is sufficient to eliminate the possibility of axial movement of the fitting members relative to each other, under the effect of different pressures on both sides of the wall.

Particularly in the middle cross section area of the wall opening, it is not always possible to ensure that fitting members are secured in a way so that they cannot move, if the ducting arrangement is intended to provide a seal capable of resisting higher pressure differences and/or the wall opening is of large cross sectional area.

In order therefore reliably to prevent fitting members from moving axially relative to each other in that way, even under unfavourable conditions and in particular also in the middle cross sectional area of the opening in the wall, the ducting arrangement may be such that the fitting members fill the cross section of the wall opening in a sector-like of sector portion-like configuration. Each sector is a two-piece part and extends from the axis of the opening in radial direction to the wall of the opening.

GB 2140114 A presents as advantage that each sector-like fitting member extends radially to the inner wall of the wall opening and is therefore pressed against that wall by the clamping flange, thereby preventing the fitting members from moving axially and directly relative to each other. Each individual fitting member is seen to be fixed to the inner wall directly by the clamping flange and also held secure against high pressure differences.

The relative position of the two pieces of the two-piece fitting member, in a direction perpendicular to the axial direction, is fixed and stable. These positions are fixed by, first of all, the cable, pipe or the like which fits in receiving means therefor in that two-piece fitting member. The receiving means are adapted in respect of shape and size to the individual cable or pipe cross sections. This ensures that the two pieces of the two-piece fitting member have a fixed position relative to each other. Secondly, the two-pieces of the two-piece fitting member are divided by a dividing plane which also extends radially to the wall opening, so that each of these two pieces is pressed against the wall opening, and the stable wall opening gives a reference plane for the relative position of the two pieces of the fitting member. Bearing in mind that the clamping flange holds the individual fitting members fixed against the inner wall of the opening, it is clear that the relative position of the two pieces of the fitting member in a plane perpendicular to the axial direction, is very stable.

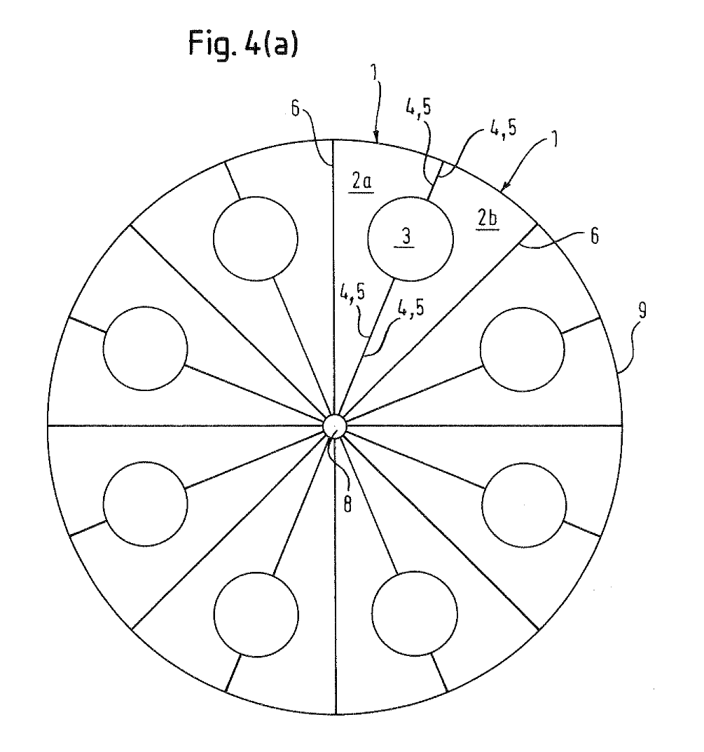

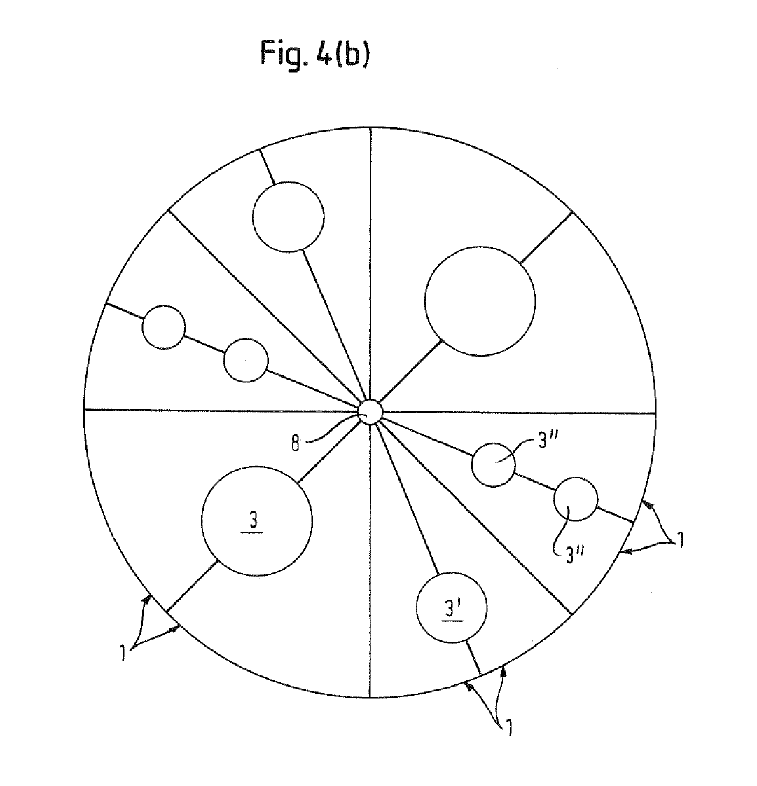

Also other systems—for sealing a round tubular opening through which in a longitudinal direction thereof one tube, duct or cable extends, are known. Many examples thereof can be found in so-called “cable penetrations”. A successful example is disclosed in WO 2004/111513, which also originated from the present inventor. That document discloses a system that comprises of at least two segmental longitudinal parts for forming a sealing plug. As shown in FIGS. 4a-4e of that document, it is possible that the system allows for sealing a space in a round tubular opening through which a multitude of tubes or ducts extend in the longitudinal direction, wherein these tubes or ducts have all the same diameter.

The segmental longitudinal parts for forming a sealing plug are on the outside provided with outer ribs. The design of these ribs is advantageously such that the tolerances in the diameter of an opening for which that system is suitable, can be in a much wider range than similar systems which are not provided with such purposefully designed outer ribs. Although a lateral movement of such a sealing plug and the longitudinal parts thereof, in a plane perpendicular to the axial direction, is consequently possible (and often advantageously used), the longitudinal parts will not move relative to each other in a lateral direction. This is because the plane which divides the sealing plug into the segmental longitudinal parts is also the plane in which the recesses are formed for receiving a cable, pipe or duct. In other words, the fixation of the segmental longitudinal parts relative to each other is, as explained above for GB 2140114 A, carried out by the occupation of the cable, pipe or duct in the dividing plane.

Also WO 2007/028443 describes examples of such a sealing system. FIG. 4 of that document shows one part in a perspective view. FIG. 4a of that document shows an example of a complete system in a perspective view. The former figure allows for sealing an annular space, whereas the latter figure allows for sealing a space in a tubular opening through which two cables extend.

Noticeably, each of these systems, as earlier disclosed in WO 2007/028443, allows for sealing a round tubular opening through which, in a longitudinal direction thereof, one or more tubes, ducts or cables extend, which all have the same diameter.

In practice it is often also desirable to have a number of differently sized tubes or ducts extending through one round tubular opening, or to pull a number of differently sized cables through one round tubular opening, and then to seal that opening. However, such a possibility should not be at the price of an enhanced risk on a failure of the sealing, even if this is not much more than a small leakage.

It is an object of the present invention to provide an assembly for sealing a round tubular opening through which in a longitudinal direction thereof at least one tube, duct or cable extends, while allowing for the possibility that a multitude of differently sized tubes, ducts or cables extend through that very same tubular opening, therewith providing an optimal and stable sealing. The assembly ideally allows for a simple installation and low maintenance once in use.

It is an object of the present invention to provide a method for providing a gas-tight and water-tight compartment in which an end or an open part of a tube, duct or cable is positioned by extending into that compartment through a round tubular opening, whilst allowing for the possibility that also a multitude of differently sized conduction tubes, ducts or cables extend into that compartment through the round tubular opening, which should lead to an optimal and stable sealing, and entails a simple installation, yet leading to a low maintenance system.

It is a further object of the present invention to provide a gas-tight compartment into which a number of tubes, ducts or cables can extend through a tubular opening into a longitudinal direction thereof.

### SUMMARY OF THE INVENTION

The invention provides an assembly of at least one pair of longitudinal plug segments. This pair is suitable for forming in an assembled condition at least a part of a rubber sealing plug for a round tubular opening in such a way that each of the at least one pair of plug segments encloses at least one cylindrical recess, for sealing occupation of at least one tube, duct or cable. This tube, duct or cable extends through the opening in a longitudinal direction thereof. Each of the plug segments has a segment side of a first type which is provided with half of the cylindrical recess. Recess-free parts of each of the segment sides of the first type are suitable for realizing sealing contact across those parts with similar recess-free parts of the segment side of the first type of the other plug segment of the pair. Each of the plug segments has a segment side of a second type for realizing sealing contact with another segment side of the second type so that in the assembled condition the pair of plug segments is provided with two segment sides of the second type. Each of the plug segments is provided with an outside having a number of outer ribs spaced apart in the longitudinal direction for realizing, in the assembled condition, contact surfaces which are endless in a circumferential direction.

Surprisingly, a pair of longitudinal plug segments in the assembled condition as part of a sealing plug as inserted into a round tubular opening does not seem to move relative to another pair of longitudinal plug segments also in the assembled condition as a part of that sealing plug, even though these two pairs bear against each other with their segment sides of the second type.

Without wishing to be bound by any theory, it is believed that the hydrostatic force radially inward is sufficient to fixate these segment sides of the second type relative to each other. It follows that there is no enhanced risk on a failure of a sealing. The installation of the sealing remains very simple, namely insertion of the sealing plug in its assembled condition into the opening through which tubes, cables or ducts extend in a longitudinal direction thereof.

Advantageously, it is now also possible to replace only a particular pair of plug segments in a situation wherein a new tube, duct or cable with a different diameter will replace a previous tube, duct or cable. There is thus no need to replace the entire sealing plug.

The outer dimensions of a new pair of plug segments are such that, in the assembled condition, these are the same as those for the previous pair of plug segments in the assembled condition, even though the enclosed cylindrical recess for sealing occupation of a new, differently sized, tube, duct or cable, will be different. Hence, it will also be possible to have a number of identically sized pairs of plug segments which can form together the sealing plug. Each of the pairs of plug segments can in the assembled condition allow for sealing occupation of a differently sized tube, duct or cable. There is no need to provide a tailor-made entirely new plug for such a situation. This saves enormously in costs, not only in terms of materials, but also in terms of moulds. There is no need to have a mould for each combination of tubes, ducts or cables as extending through a round tubular opening. There is only a need for a mould for each pair of segments that has a differently sized cylindrical recess. This also allows for flexibility in the planning stage of a network of tubes, ducts or cables.

In an embodiment, recess-free parts of the segment side of the second type comprise a flat surface. This facilitates sealing by the plug segments as the flat surfaces of the recess-free parts of the segment side of the second type will easily match. Furthermore, it allows for straightforward insertion and/or removal of a respective pair of plug segments. Any forces which need to be transmitted from one of the assembled plug segments to another one of the assembled plug segments will take place via two parts of material which have a simple interface. The two flat surfaces pressed against each other, will not cause an additional factor to be taken into account when considering any of the phenomena that may lead to irreversible deformations. The distribution of pressure is hardly interrupted by such an interface, if at all.

In an embodiment, the segment side of the second type comprises a flat surface. This facilitates insertion and removal of the respective pair of plug segments. Also the sealing capacity will correspondingly benefit from such a flat surface as the contact surfaces will easily match everywhere. The advantage outlined above for the flat surface of the recess-free parts in relation to stress distribution, equally applies to the flat segment sides of the second type.

In an embodiment each plug segment is provided with an inside, such that in use of the assembly as the sealing plug the insides form together a central channel for tightly fitting occupation of a cylindrical part. This not only allows for a very good sealing fit at a point where all plug segments come together, it also offers the possibility of having an additional channel in a central part of the sealing plug, which can be used for various beneficial purposes.

The invention, exemplary embodiments thereof, and further advantages will further be explained below, in conjunction with the drawing, which shows in:

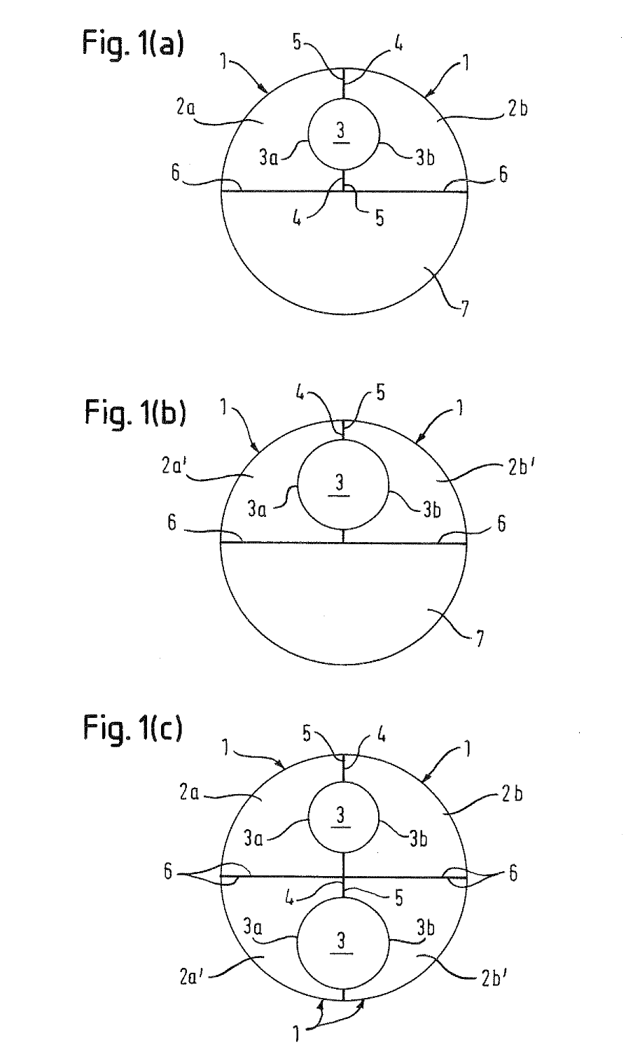

FIG. 1(a) schematically in transverse cross-section a first embodiment of an assembly in accordance with the invention, in a sealing plug for a round tubular opening;

FIG. 1(b) schematically in transverse cross-section a second embodiment of an assembly in accordance with the invention, in a sealing plug for a round tubular opening;

FIG. 1(c) schematically in transverse cross-section a third embodiment of an assembly in accordance with the invention, in a sealing plug for a round tubular opening;

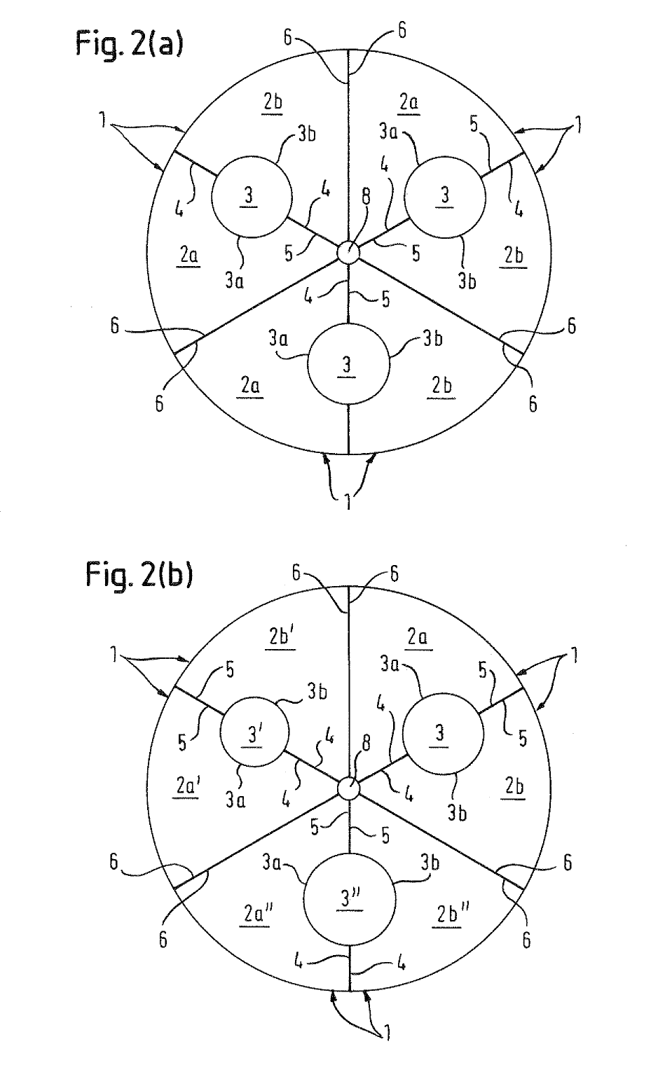

FIG. 2(a) schematically in transverse cross-section a fourth embodiment of an assembly in accordance with the invention, in a sealing plug for a round tubular opening;

FIG. 2(b) schematically in transverse cross-section a fifth embodiment of an assembly in accordance with the invention, in a sealing plug for a round tubular opening;

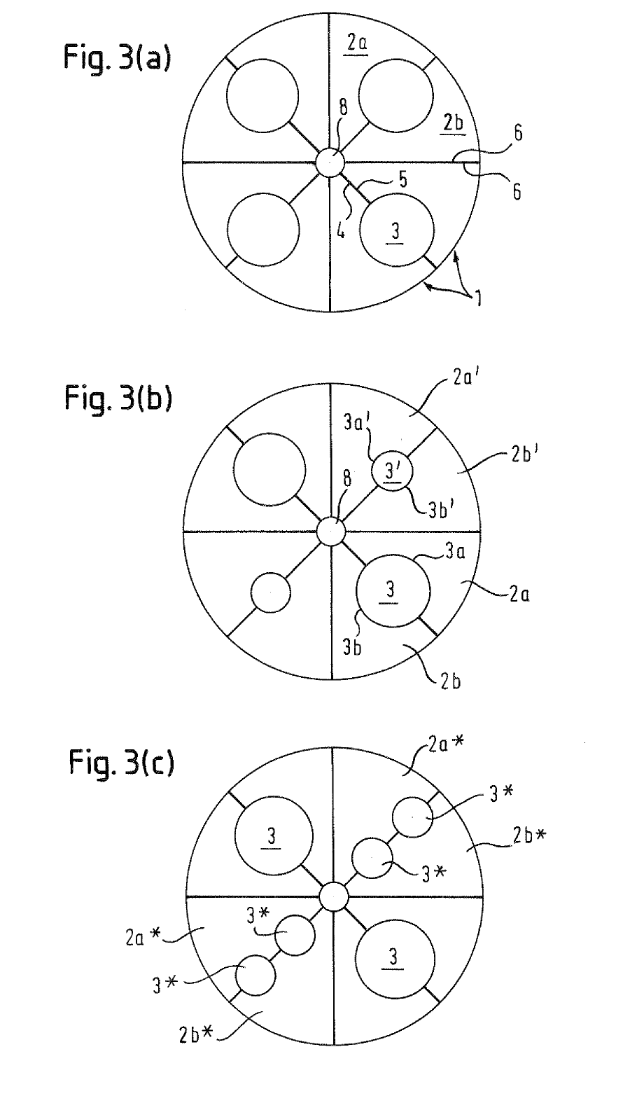

FIG. 3(a) schematically in transverse cross-section a sixth embodiment of an assembly in accordance with the invention, in a sealing plug for a round tubular opening;

FIG. 3(b) schematically in transverse cross-section a seventh embodiment of an assembly in accordance with the invention, in a sealing plug for a round tubular opening;

FIG. 3(c) schematically in transverse cross-section an eighth embodiment of an assembly in accordance with the invention, in a sealing plug for a round tubular opening;

FIG. 4(a) schematically in transverse cross-section a ninth embodiment of an assembly in accordance with the invention, in a sealing plug for a round tubular opening;

FIG. 4(b) schematically in transverse cross-section a tenth embodiment of an assembly in accordance with the invention, in a sealing plug for a round tubular opening;

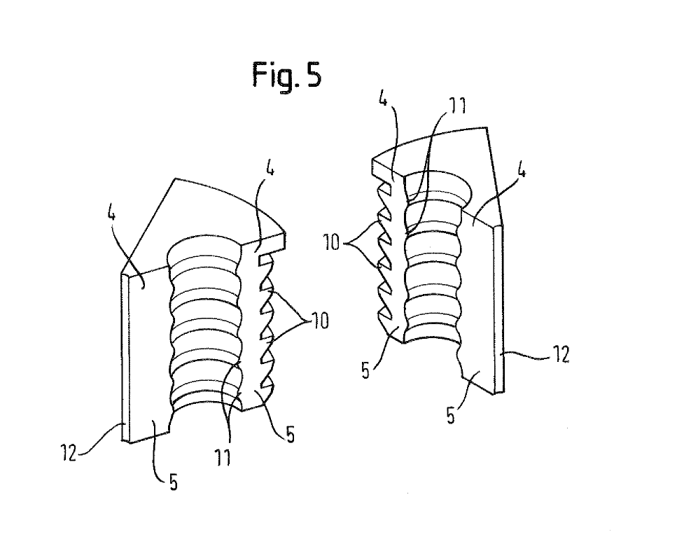

FIG. 5 in perspective view and non-assembled condition an embodiment of an assembly in accordance with the invention;

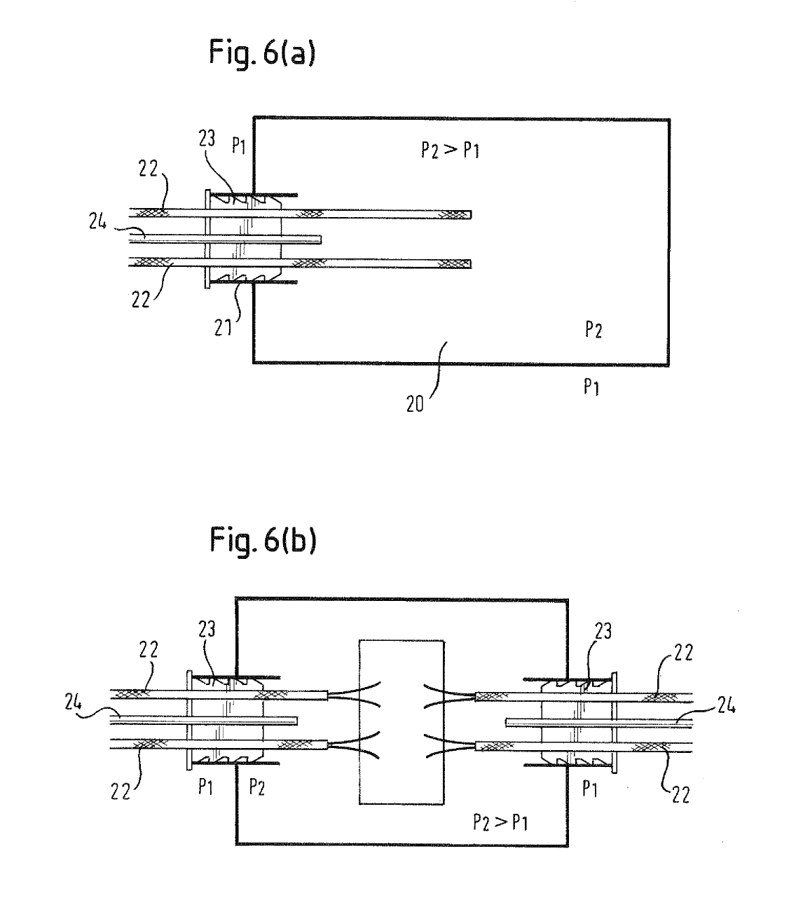

FIG. 6(a) schematically in longitudinal cross-section a first embodiment of use of an assembly in accordance with the invention and schematically in longitudinal cross-section a first embodiment of a gas-tight compartment in accordance with the invention;

FIG. 6(b) schematically in longitudinal cross-section a second embodiment of use of an assembly in accordance with the invention and schematically in longitudinal cross-section a second embodiment of a gas-tight compartment in accordance with the invention;

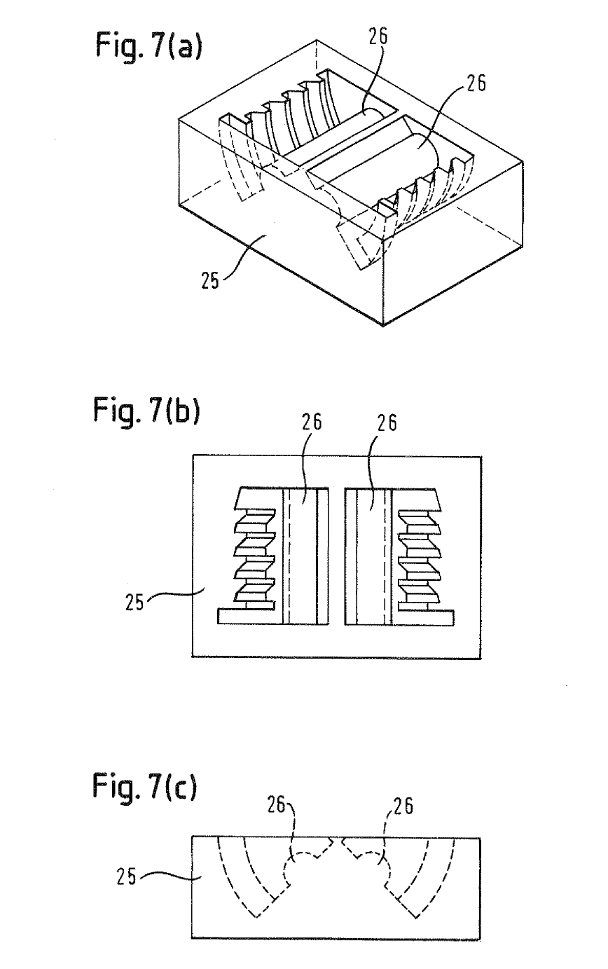

FIG. 7(a) schematically in a perspective view a mould for manufacturing an assembly in accordance with the invention;

FIG. 7(b) a top view of the mould shown in FIG. 7(a); and

FIG. 7(c) a cross sectional view of the mould shown in FIG. 7(a).

In the drawing, like parts are provided with like references.

FIGS. 1(a)-4(b) show schematically embodiments of an assembly in accordance with the invention. The assembly comprises a pair 1 of longitudinal plug segments 2a, 2b for forming in an assembled condition (as shown in cross-section of a sealing plug for a round tubular opening) a pair 1 of plug segments 2a, 2b that encloses a cylindrical recess 3 for sealing occupation of, for instance, a tube, a duct or a cable (not shown, but as extending through the opening in a longitudinal direction thereof). Each of the plug segments is of a suitable rubber about which more information follows later in this specification. Each of the plug segments 2a, 2b has a segment side of a first type 4. Such a segment side of the first type is provided with half 3a, 3b of the cylindrical recess 3. Recess-free parts 5 of each of the segment sides of the first type 4 are suitable for realizing sealing contact across those parts 5 with similar recess-free parts 5 of the segment side of the first type of the other plug segment 2a, 2b of the pair 1. Such a pair 1 is clearly shown in each of the FIGS. 1(a)-4(b).

Each of the plug segments 2a, 2b has a segment side of a second type 6 for realizing sealing contact across that second side 6 with another segment side of the second type 6 so that in the assembled condition (as shown) the pair 1 of plug segments 2a, 2b is provided with two segment sides of the second type 6. For the particular embodiment shown in FIG. 1(a)-1(c) the pair of plug segments 2a, 2b has in the assembled condition two segment sides of the second type 6, which are in line with each other.

FIGS. 1(a)-4(b) show the assembly of a pair 1 of longitudinal plug segments 2a, 2b in an assembled condition for sealing a round tubular opening through which in a longitudinal direction thereof one tube, duct or cable extends. However, for the sake of clarity, in FIGS. 1-4 neither the round tubular opening, nor any of the tubes, ducts or cables is shown.

The assembled plug as shown in FIG. 1a as viewed in a longitudinal direction, also comprises a so-called “blind” plug segment 7. Such a plug segment 7 has no cylindrical recess 3.

Advantageously, should a tube, duct or cable occupying in use of the assembly shown in FIG. 1(a) the cylindrical recess 3 need to be replaced by another tube, duct or cable with a slightly larger (or smaller) diameter, then only the pair 1 of the longitudinal segments 2a, 2b will need to be replaced by a pair 1 of longitudinal segments 2a′, 2b′, as for instance shown in FIG. 1(b).

Also advantageously, should in addition to the tube, duct or cable which occupies in use of the assembly cylindrical recess 3, another tube, duct or cable need to be inserted into the tubular opening, then only the blind segment 7 will need to be replaced by another pair 1 of longitudinal plug segments 2a, 2b, 2a′, 2b′. If the extra tube, duct or cable is in diameter identical to the tube, duct or cable already extending through the tubular opening, then an identical pair 1 of longitudinal plugs segments 2a, 2b can be inserted as replacement of blind segment 7. Should the extra tube, duct or cable have a larger diameter than the diameter of the tube, duct or cable already extending through the tubular opening, then another pair 1 of longitudinal plug segments 2a′, 2b′ should replace blind segment 7 as, for instance, shown in FIG. 1(c).

To facilitate insertion as well as removal of the respective plug segments 2a, 2b or a blind segment 7, the recess-free parts 5 of the segment side of the first type 4 preferably comprise a flat surface, just as the segment side of the second type 6 preferably comprises a flat surface. Furthermore, such a flat surface provides for an optimal match between two of such flat surfaces to optimize sealing, as well as the distribution of stresses which, in turn, reduces stress relaxation.

FIG. 2(a) shows schematically an embodiment of an assembly in accordance with the invention wherein the assembly comprises a plurality of pairs 1 of longitudinal plug segments 2a, 2b. Again, each of the pairs 1 is shown in its assembled condition. That is, each pair 1 of plug segments 2a, 2b encloses a cylindrical recess 3 for sealing occupation of a tube, duct or cable (not shown). Although not shown in FIG. 2a-4(b) each pair 1 of longitudinal plug segments 2a, 2b could, if so desired, be replaced by a blind segment 7 having segment sides of the second type 6. Such a blind plug segment 7 has in such a situation outer dimensions which are equal to the outer dimensions of a pair of longitudinal plug segments 2a, 2b in its assembled condition. The plug segments 2a, 2b, 2a′ 2b′, 2a″ 2b″ as shown in FIGS. 2(a) and 2(b) also have each a segment side of a first type 4 which is provided with half 3a, 3b, 3a′, 3b′, 3a″, 3b″ of the cylindrical recess 3, 3′, 3″. Recess-free parts 5 of each of the segment sides of the first type 4 are, as shown, suitable for realizing sealing contact across those parts 5 with similar recess-free parts 5 of the segment side of the first type 4 of the other plug segments 2a, 2b, 2a′ 2b′, 2a″ 2b″ of the pair 1. Again, each of the plug segments has a segment side of a second type 6 for realizing sealing contact across that segment side 6 with another segment side of the second type 6 so that in the assembled condition each pair 1 of plug segments is provided with two segment sides of the second type 6.

In FIG. 2(a) the cylindrical recess 3 formed in the assembled condition of each of the pairs 1 has a uniform diameter. However, in FIG. 2(b) each of the cylindrical recesses 3, 3′, 3″ formed in the assembled condition of each of the pairs 1 differs in diameter from any of the other cylindrical recesses 3, 3′, 3″. One can easily imagine that, as shown, in the assembled condition a plug is formed with the plurality of pairs 1 of longitudinal segments 2a, 2b, 2a′ 2b′, 2a″ 2b″ for sealing a tubular opening through which in a longitudinal direction thereof three tubes, ducts or cables extend. One can also easily imagine that each pair 1 of plug segments 2a, 2b, 2a′ 2b′, 2a″ 2b″ can easily be removed, so that a tube, duct or cable that occupied the cylindrical recess 3, 3′, 3″ in that pair 1 can be removed and replaced by a tube, duct or cable having a diameter that differs from the diameter of the removed tube, duct or cable.

As shown, preferably each of the pairs 1 of the plug segments 2a, 2b, 2a′ 2b′, 2a″ 2b″ has in the assembled condition the same outer dimensions as any of the other pairs 1 of plug segments 2a, 2b have in the assembled condition.

Although it is possible to have a plug formed on the basis of one pair I of longitudinal plug segments 2a, 2b and a blind segment 7 (shown in FIG. 1(a) and FIG. 1(b)), the assembly may also comprise at least two pairs 1 of the longitudinal plug segments 2a, 2b, 2a′ 2b′, 2a″ 2b″ so as to allow for forming in the assembled condition a plug.

FIGS. 2(a) and 2(b) also show a central channel 8 which is not shown in FIGS. 1(a)-1(c). Further on in this specification, information on and purpose of this central channel 8 will be provided and explained in detail.

FIG. 3(a)-3(c) show embodiments of assemblies in accordance with the invention wherein each pair 1 of plug segments 2a, 2b forms in the assembled condition a quadrant of a plug which has a circular transverse cross section (only for the sake of clarity the number of reference signs used is less than in the previously discussed figures). It is of course also possible that one quadrant is formed by a so-called “blind segment”, i.e. a segment that has rectangular sides of the second type 6 which are not provided with half of a cylindrical recess. Instead of a blind segment 7 for forming a quadrant, it is also possible that two smaller blind segments 7 form in an assembled condition a quadrant. In FIG. 3(b) a plug is shown wherein two of the quadrants have a relatively small cylindrical recess 3′ as compared to the cylindrical recess 3 of the other two quadrants.

In FIG. 3(c) an embodiment is shown wherein the longitudinal plug segments 2a*, 2b* have each a segment side of the first type 4 provided with two halves of the cylindrical recess 3* along the segment side of the first type 4. For a skilled person it will be clear that each pair of longitudinal plug segments 2a, 2b, 2a′ 2b′, 2a″ 2b″, 2a*, 2b* can enclose more than one cylindrical recess 3, 3′, 3″, 3* for sealing occupation of more than one tube, duct or cable, provided that the diameter of the respective tubes, ducts or cables in relation to the size of the assembled pair of longitudinal plug segments 2a, 2b, 2a′ 2b′, 2a″ 2b″, 2a*, 2b* allows for this multitude of cylindrical recesses 3*.

FIG. 4(a) shows schematically by way of a further example an embodiment wherein eight pairs 1 of longitudinal plug segments 2a, 2b are positioned in an assembled condition for forming a plug for sealing a round tubular opening.

FIG. 4(b) shows by way of a further example a combination of different pairs of longitudinal plug segments for forming such a plug. Again, for a skilled person it will be clear that in principle any Combination is possible.

Where in the assembled condition of the assembly a plug is formed for sealing a tubular opening through which in the longitudinal direction thereof tubes, ducts or cables extend, it is preferable that each of the plug segments is provided with an outside 9 having a number of outer ribs 10. FIG. 5 shows in a perspective view plug segments 2a, 2b and outer ribs 10. These outer ribs are spaced apart in the longitudinal direction for realizing, in the assembled condition, contact surfaces (not shown) which are endless in a circumferential direction. Such an outside 9 provides optimal sealing along an inner wall (not shown) of a tubular opening. Preferably, the outer ribs are as disclosed in WO 2004/111513 of the same inventor. The outer ribs on such an outside are disclosed in more detail in FIG. 1 of that document and described by the accompanying text in the description of that figure. The advantages attributed to these outer ribs equally apply in the present invention.

Each cylindrical recess 3, 3′ and of course also each half of cylindrical recess 3, 3′ is preferably provided with inner ribs 11, preferably such as those described in WO 2007/028443, also of the same inventor. FIG. 1 and FIG. 1(a) of that document disclose, in conjunction with the accompanying description of those figures in that document, in more detail how the inner ribs 11 are preferably shaped. Again, the advantages described there equally apply in the present invention. Each cylindrical recess 3, 3′ is provided with inner ribs 11 for realizing, in use, annular contact surfaces of which each is closed in itself in circumferential direction.

The inner ribs 11, and outer ribs 10, contribute enormously to a reduction of the stresses present in a plug formed by the assembly as well as to a reduction of forces applied to the cables, tubes or ducts. The inner ribs 11, and outer ribs 10, “absorb” much of these stresses and forces.

A plug formed by assembling an appropriate number of appropriately sized pairs of plug segments is very capable of providing a good sealing along the outside of the plug due to a good contact of the plug along the inner wall of the tubular opening, a good contact along each of the segment sides of the first type and a good contact along each of the segment sides of the second type, as well as along the cylindrical recesses.

In a plug formed by a plurality of assemblies in accordance with the present invention, a critical point is formed at a position where a relatively large number of plug segments come together, i.e. on/at the center of the plug. The present inventor has addressed this potential problem by providing each plug segment with an inside 12, such that in use of the assembly in a sealing plug the insides 12 form together a central channel (central channel 8 as briefly referred to earlier on) for tightly fitting occupation of a cylindrical part. By inserting the tightly fitting cylindrical part a good sealing is thus obtained at a point where a plurality of plug segments comes together in a plug formed by appropriately assembling all these plug segments.

Although it is perhaps unconventional, at this point in a specification, it is worth referring again to other systems for so-called “cable penetrations”, to further outline advantages of the present invention.

The problems of GB 2186442 do not occur to the same extent with any of the embodiments of the present invention, if occurring at all.

Excessive pressure is not possible due to the fact that the dimensions of the round tubular opening remain constant and the sealing plug can only be formed within the opening if the assembled pairs are well-selected in relation to the size of the tubular opening and in relation to the diameters of the tubes, ducts or cables extending through the opening. There is no possibility that the opening will temporarily be enlarged for positioning of the plug segments to then reduce the dimensions of the opening again for applying a pressure to the plug segments. This provides an enormous advantage over systems such as those described in GB 2186442. With the present invention, the need for insertion in a space that is fixed in size, implies that the plug segments will only be pressurized in a range in which irreversible changes of the plug segments are over time minimal, if taking place at all. Phenomena of stress relaxation in the rubber and creep in the tube, duct or cable (or the sheathing thereof) hardly occur, if at all. As explained earlier, the advantages of the outer ribs 10 can be in accordance with those described in WO 2004/11153 and the advantages of the inner ribs 11 can be in accordance with those described in WO 2007/28443.

Furthermore, the plug segments are subjected to radial forces, i.e. almost hydrostatically, so that responses are likely to be the same in all directions. This also allows for the replacement of an assembled pair of plug segments that, in the assembled condition, has the same outer dimensions as the removed pair had in the assembled condition.

It is also clear that a plug formed on the basis of embodiments of the invention can easily cope with some lateral movements of tubes, ducts or cables relative to the tubular opening. This does not necessarily affect the sealing, or its long-term performance. Such lateral movements may be due to vibrations generated by passing traffic and the like.

FIG. 6(a) shows schematically in longitudinal cross-section a first embodiment of a gas-tight compartment 20 provided with a round tubular opening 21 through which in a longitudinal direction thereof two cables 22 extend. An embodiment of an assembly in accordance with the invention is used for sealing the tubular opening. In the central channel 8 of the sealing plug 23 the cylindrical part 24 comprises a valve for establishing a pressure difference between one side of the sealing plug 23 and the other side of the sealing plug 23. In this way it will be possible to raise the pressure P2 inside the gas-tight compartment, relative to the atmospheric pressure P1 outside the gas-tight compartment. This will provide a further “barrier” for gases to enter the gas-tight compartment.

FIG. 6(b) shows an alternative embodiment of such a gas-tight compartment 20. In this embodiment it is shown how an end or an open part of each cable 22 is positioned in the compartment by extending through the round tubular openings. Gas-tight compartment 20 as shown in FIG. 6(b) therefore schematically represent a cabinet in which electrical switches are positioned. Also in this gas-tight compartment the high pressure may be maintained, for instance by initially flushing the compartment with nitrogen gas to then raise the pressure inside the gas-tight compartment, so that for instance any volatile gases present in the atmosphere around the gas-tight compartment cannot easily enter the gas-tight compartment and not cause fire, explosions and the like. It is envisaged that such gas-tight compartments as present in road ducts, for regulating traffic light systems etc, will benefit from this application of an assembly in accordance with the invention.

FIG. 7(a) shows a mould 25 for producing a pair of longitudinal plug segments by a moulding method. FIG. 7(b) shows a top view of mould 25 whereas FIG. 7(c) shows a cross-sectional view of mould 25. Advantageously, a single mould 25 can be used for producing for a round tubular openings all plug segments needed to form a sealing plug in that round tubular opening. Mould 25 comprises a part 26 for forming half of the cylindrical recess in each plug segment. The part 26 can be removable and/or replaceable by another part 26 to allow for using mould 25 for making a pair of longitudinal plug segments that encloses in the assembled condition a differently sized cylindrical recess or that does not comprise a recess. Although such production methods are known to a person skilled in the art, mould 25 is shown and briefly described to further underline one of the advantages of the present invention.

The elastic material, usually a rubber, employed for the production of the segmental longitudinal parts is preferably of fire-resistant quality. The rubber may be designed such that it expands in response to an exposure to elevated temperatures. It is also possible to use silicon rubber. A suitable EPDM may also be employed. The hardness may, for instance, be 70 Shore A. Any rubber with sufficient flexibility and a compression set that is similar to the compression set of EPDM is suitable.

The plug segments can manually be inserted into a tubular opening for forming the sealing plug 23. This process can be facilitated by greasing in the plug parts, for instance with vaseline. After settlement of the plug and disappearance of the effects of vaseline, the plug can easily withstand a pressure of 2 bar.

It is also possible to test the sealing of the plug almost immediately after installation of the plug, using the central channel 8. A simple hand pump will be enough to establish resistance against further pumping in of air through that channel 8, thus giving an indication that a sealing has been provided.

The invention is by no means limited to the embodiments and examples described above. The cylindrical part that can be used for tightly fitting occupation in central channel 8 can be of metal but also of a hard plastic such as polyetheremide (PEI) or polyethersulfonamide (PES). The cylindrical part can be solid, i.e. not tubular-like, so that it seals off central channel 8. It is also possible to use central channel 8 for guiding (in a tightly fitting fashion) a cable for earthing components in a gas-tight compartment. In relation to this it is to be noted that also an electrically conductive rubber may be used for production of an assembly in accordance with the present invention.

Many other variations are conceivable within the context of the appended claims. Each of those embodiments is seen to be falling within the framework of the present invention.

1. An assembly of at least one pair of longitudinal plug segments for forming in an assembled condition at least a part of a rubber sealing plug for a round tubular opening such that each of the at least one pair of plug segments encloses at least one cylindrical recess for sealing occupation of at least one tube, duct or cable which extends through the opening in a longitudinal direction thereof, wherein each of the plug segments has a segment side of a first type which is provided with half of the cylindrical recess, wherein recess-free parts of each of the segment sides of the first type are suitable for realizing sealing contact across those parts with similar recess-free parts of the segment side of the first type of the other plug segment of the pair, wherein each of the plug segments has a segment side of a second type for realizing sealing contact across that segment side with another segment side of the second type so that in the assembled condition the pair of plug segments is provided with two segment sides of the second type, wherein each of the plug segments is provided with an outside having a number of outer ribs spaced apart in the longitudinal direction for realizing, in the assembled condition, contact surfaces which are endless in a circumferential direction.

2. An assembly according to claim 1, wherein recess-free parts of the segment side of the first type comprise a fiat surface.

3. An assembly according to claim 1, wherein the segment side of the second type comprises a flat surface.

4. An assembly according to claim 1, wherein the assembly comprises a plurality of such pairs of longitudinal plug segments and/or further at least one blind plug segment having segment sides of the second type, so that in the assembled condition of the assembly the sealing plug is formed.

5. An assembly according to claim 4, wherein each cylindrical recess is provided with inner ribs for realizing, in use, annular contact surfaces of which each is closed in itself in circumferential direction.

6. An assembly according to claim 1, comprising at least two pairs of the longitudinal plug segments.

7. An assembly according to claim 6, wherein the cylindrical recess formed in the assembled condition of each of the pairs, has a uniform diameter.

8. An assembly according to claim 6, wherein at least one of the cylindrical recesses formed in the assembled condition of each of the pairs, differs in diameter from any of the other cylindrical recesses.

9. An assembly according to claim 1, wherein each of -he pairs of plug segments has in the assembled condition the same outer dimensions as any of the other pairs of plug segments have m the assembled condition.

10. An assembly according to claim 1, wherein each plug segment is provided with an inside, such that m use of the assembly as the sealing plug the insides form together a central channel for tightly fitting occupation of a cylindrical part.

11. An assembly according to claim 10, wherein the assembly comprises the cylindrical part.

12. An assembly according to claim 10, wherein the cylindrical part comprises a valve for establishing, in use, a pressure difference between one side of a sealing formed by the assembly and the other side of that sealing.

13. Use of an assembly according to claim 1, for providing a gas-tight compartment in which an end or an open part of a tube, duct or cable is positioned by extending into that compartment through a round tubular opening, wherein the use comprises forming a sealing plug in the round tubular opening.

14. Use according to claim 13 of an assembly wherein the use comprises establishing a pressure difference between one side of a sealing formed by the assembly and the other side of that sealing.

15. A gas-tight compartment provided with at least one round tubular opening through which in a longitudinal direction thereof at least one tube, duct or cable extends, wherein the round tubular opening is sealed off with at least one assembly according to claim 1.
